(19) United States
(12) Patent Application Publication
(10) Pub. No.: US 2003/0161709 A1
(43) Pub. Date: Aug. 28, 2003

(54) Pivoting, sloped side panels for a truck body

(76) Inventors: Charles S. Musso JR., Hammondsport, NY (US); Tom Musso, Bath, NY (US)

Correspondence Address: George R. McGuire, Hancock & Estabrook, LLP, 1500 Mony Tower I, P.O.Box 4976, Syracuse, NY, 13221-1976, US

(21) Appl. No.: 10/082,471

(22) Filed: Feb. 22, 2002

(51) Int. Cl. B65G 15/00

(52) U.S. Cl. 414/528

(57) ABSTRACT

A dump truck body including a receptacle defined by a floor and, extending from the floor, first and second side walls on opposite sides of the floor, and a front wall extending between the side walls, wherein the first and second side walls have a first longitudinal edge distal from the floor and a second longitudinal edge proximal to the floor. The dump truck body further includes at least one first sloped panel having a first longitudinal edge and a second longitudinal edge, wherein the first longitudinal edge of the at least one first sloped panel is pivotally connected at or adjacent the first longitudinal edge of the first side wall for pivotal movement between a raised position adjacent the first side wall and a lowered position extending angularly between the first side wall and the floor.

### FIELD OF THE INVENTION

This invention relates generally to a dump truck body which includes pivoting, sloped side panels which may be attached to first longitudinal edges of the side walls distal to the floor of the dump truck body or may be attached to the floor of the dump truck body adjacent a longitudinally extending conveyor system.

### BACKGROUND OF THE INVENTION

Dump trucks are often used to transport and disperse particulate material, such as salt, gravel, and soil. Conventional dump truck bodies include a planar floor and, extending substantially perpendicularly from the floor, two side walls on opposite sides of the floor, a front wall, and a tailgate. Typically, conveyors or augers have been installed in truck bodies to extend between the front wall and the tailgate of the dump body and centrally between the side walls of the truck body. With these longitudinal conveyors or augers, material in the dump bodies can be conveyed to the front or rear of the dump body to be dispensed. Some examples of these types of trucks are disclosed in U.S. Pat. No. 4,886,214 to Musso, Jr. et al., U.S. Pat. No. 5,310,119 to Musso, Jr. et al., U.S. Pat. No. 5,397,172 to Musso, Jr. et al., U.S. Pat. No. 5,400,974 to Musso, Jr. et al., U.S. Pat. No. 5,437,400 to Musso, Jr. et al., and U.S. Pat. No. 5,437,499 to Musso.

However, with a flat floor and perpendicularly extending side walls, front wall, and tailgate of a typical dump truck body, all of the material within the truck body does not flow by gravity into the conveyor or auger assembly. This necessitates movement of the material adjacent the side walls and front and back corners of the dump truck body to the conveyor or auger assembly, either by manually moving the material toward the conveyor or auger assembly (e.g., by shoveling or sweeping) or by the combined use of manual movement and pivoting of the dump truck body using a lift system.

Some dump truck bodies have incorporated sloped floors or sloped plates extending between the floor and the side walls, thus eliminating the need to move material from the corners of the dump truck body. However, such sloped plates often need to be manually carried or slid into position in the dump truck body. In addition, the sloped plates typically only extend partially up the side walls of the dump truck body when in use. Therefore, the material within the dump body does not move easily toward the center of the dump truck body for contact with a centrally located conveyor system. In addition, the centrally located conveyor system is exposed to the material within the dump truck body even when not in use.

Accordingly, there remains a need for a multi-purpose dump truck body which includes sloped, side panels moveable between an operative and inoperative position which, in the operative position, allow the material within the dump body to move easily toward a centrally located conveyor system. In addition, there remains a need for the above-described dump truck body further including a device for covering and protecting a centrally located conveyor system when not in use.

### SUMMARY OF THE INVENTION

The present invention relates to a dump truck body including a receptacle defined by a floor and, extending from the floor, first and second side walls on opposite sides of the floor, and a front wall extending between the side walls, wherein the first and second side walls have a first longitudinal edge distal from the floor and a second longitudinal edge proximal to the floor. The dump truck body further includes at least one first sloped panel having a first longitudinal edge and a second longitudinal edge, wherein the first longitudinal edge of the at least one first sloped panel is pivotally connected at or adjacent the first longitudinal edge of the first side wall for pivotal movement between a raised position adjacent the first side wall and a lowered position extending angularly between the first side wall and the floor.

The present invention also relates to a dump truck including a longitudinally extending truck frame, a dump truck body as described above pivotally mounted at a rear end thereof on the truck frame, and a lift system connected between the truck frame and a forward end of the dump body.

Another aspect of the present invention relates to a dump truck body including a receptacle defined by a floor and, extending from the floor, first and second side walls on opposite sides of the floor, and a front wall extending between the side walls, wherein the first and second side walls have a first longitudinal edge distal from the floor and a second longitudinal edge proximal to the floor. The dump truck body further includes a longitudinally extending conveyor system structurally integrated into the floor between the first and second side walls, wherein the floor has at least one opening in alignment with the conveyor system. In addition, the dump truck body includes at least one first sloped panel having a first longitudinal edge and a second longitudinal edge, wherein the second longitudinal edge of the at least one first sloped panel is pivotally connected to the floor adjacent the longitudinally extending conveyor system for pivotal movement between a lowered position covering the conveyor system and a raised position extending angularly between the first side wall and the floor.

Yet another aspect of the present invention relates to a dump truck including a longitudinally extending truck frame, a dump truck body as described in the previous paragraph pivotally mounted at a rear end thereof on the truck frame, and a lift system connected between the truck frame and a forward end of the dump body.

The present invention also relates to a dump truck body including a receptacle defined by a floor and, extending from the floor, first and second side walls on opposite sides of the floor, and a front wall extending between the side walls, wherein the first and second side walls have a first longitudinal edge distal from the floor and a second longitudinal edge proximal to the floor. The dump truck body also includes a longitudinally extending conveyor system structurally integrated into the floor between the first and second side walls, wherein the floor has at least one opening in alignment with the conveyor system. In addition, the dump truck body includes at least one first sloped panel having a first longitudinal edge and a second longitudinal edge, wherein the first longitudinal edge of the at least one first sloped panel is pivotally connected at or adjacent the first longitudinal edge of the first side wall or to the floor adjacent the longitudinally extending conveyor system for pivotal movement between a sloped position extending angularly between the first side wall and the floor and a non-sloped position.

Another aspect of the present invention relates to a dump truck including a longitudinally extending truck frame, a dump truck body as described in the previous paragraph pivotally mounted at a rear end thereof on the truck frame, and a lift system connected between the truck frame and a forward end of the dump body.

The pivoting, sloped side panels of the present invention allow a typical dump truck body to be easily converted to form a sloped hopper, without the need for manually inserting hopper attachments into a square corner dump truck body. Further, when not in use, the pivoting, sloped side panels of the present invention may be stored within a recess within the side walls, or over an integrated conveyor system in the floor, to form substantially planar side walls or a substantially planar floor for holding materials as in a typical square corner dump truck body. Moreover, the pivoting, sloped side panels of the present invention preferably extend from a top edge of the side walls, to allow material within the dump truck body to easily move toward the centrally located conveyor. In addition, in the embodiment of the present invention where the pivoting, sloped side panels are pivotally attached to the floor of the dump truck body adjacent the conveyor system, the pivoting, sloped side panels function to protect the conveyor system when placed in the lowered, horizontal position. Thus, when the conveyor system is not in use, the dump truck body of the present invention can be used as a typical dump truck body, without exposing the conveyor system to the material held within the dump truck body.

### BRIEF DESCRIPTION OF THE DRAWINGS

FIG. 1 is a perspective view of a dump body in accordance with the present invention with pivoting, sloped side panels in a lowered position extending angularly between the side walls and the floor;

FIG. 2 is a perspective view of the dump body of FIG. 1 with the pivoting, sloped side panels in a substantially vertical raised position;

FIG. 3 is an end view of the dump body of FIG. 1 with a first pivoting, sloped side panel in a substantially vertical raised position and a second pivoting, sloped side panel in a lowered position extending angularly between the side walls and the floor;

FIG. 4 is an end view of the dump body in accordance with the present invention including a sliding attachment for the pivoting, sloped side panels;

FIG. 5 is an end view of a dump body in accordance with a second embodiment of the present invention with pivoting, sloped side panels in a raised position extending angularly between the side walls and the floor;

FIG. 6 is an end view of the dump body of FIG. 5 with the pivoting, sloped side panels in a substantially horizontal lowered position covering the conveyor system;

FIG. 7 is a perspective view of the dump body of FIG. 5;

FIG. 8 is an end view of a dump body in accordance with the present invention including substantially parallel pivoting, sloped side panels;

FIG. 9 is an end view of a dump body in accordance with a third embodiment of the present invention including hydraulically powered pivoting, sloped side panels; and

FIG. 10 is a side view of a truck including a dump body in accordance with the present invention.

### DETAILED DESCRIPTION OF THE INVENTION

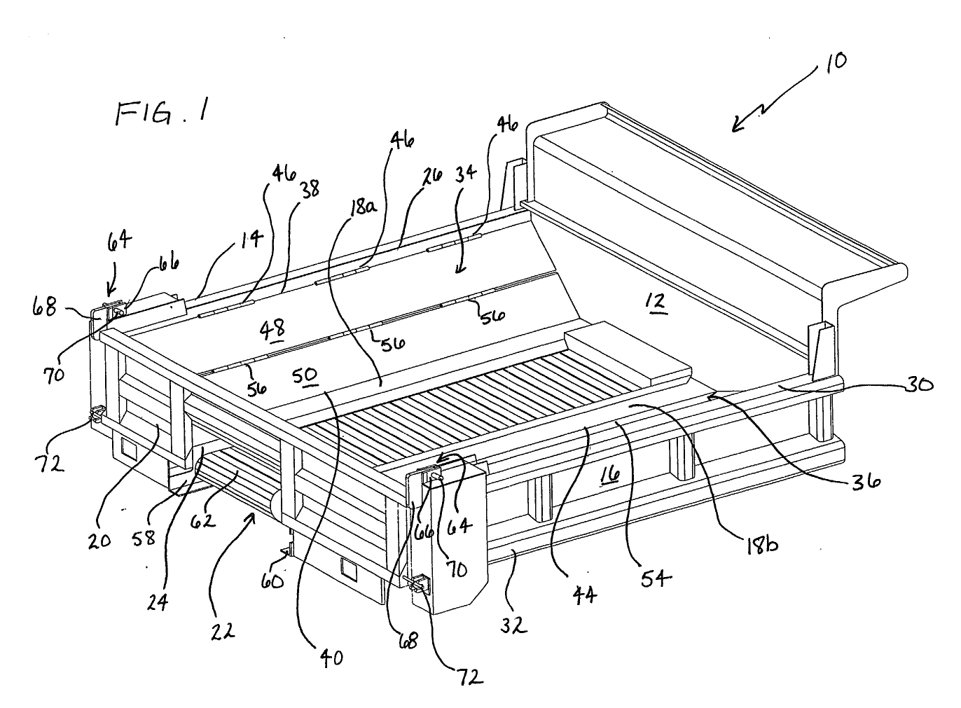

A dump body 10 in accordance with the present invention is illustrated in FIGS. 1-10. The dump body 10 includes a front wall 12, a pair of opposing side walls 14 and 16, a floor 18 (18a and 18b), a tailgate 20, a conveyor system 22, and an aperture 24. The dump body 10 provides a number of advantages, including easy conversion to a sloped hopper and easy storage of the sloped side panels within a recess within the side walls, or over an integrated conveyor system in the floor, to form substantially planar side walls or a substantially planar floor for holding materials as in a typical square corner dump truck body. Moreover, the pivoting, sloped side panels allow material within the dump truck body to easily move toward the centrally located conveyor and, where the pivoting, sloped side panels are pivotally attached to the floor of the dump truck body adjacent the conveyor system, the pivoting, sloped side panels function to protect the conveyor system when placed in the lowered, horizontal position.

Referring to FIGS. 1-3, dump body 10 includes front wall 12, opposing side walls 14 and 16, floor 18, and tailgate or back wall 20, which are connected together to form a receptacle. More specifically, front wall 12 is secured at approximately right angles along a lower edge to floor 18 and along opposing side edges to a front edge of each side wall 14 and 16. Tailgate 20 is perpendicularly secured to a back edge of each side wall 14 and 16. Each of the side walls 14 and 16 is secured at approximately right angles along a lower edge to a side of floor 18. In an alternative embodiment, side walls 14 and 16 and tailgate 20 may be secured so that they do not extend substantially perpendicularly from the floor. First side wall 14 includes a first longitudinal edge 26 distal from the floor 18 and a second longitudinal edge 28 proximal to the floor 18. Similarly, second side wall 16 includes a first longitudinal edge 30 distal from the floor 18 and a second longitudinal edge 32 proximal to the floor 18.

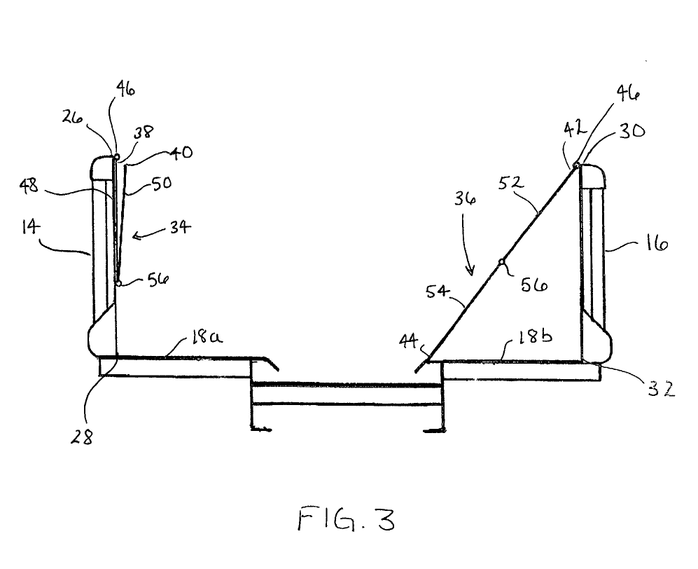

The dump body 10, as shown in FIGS. 1-3, includes first and second, sloped panels (sloped, side panels) 34 and 36 attached to the side walls 14 and 16, respectively. First sloped panel 34 includes a first longitudinal edge 38 and a second longitudinal edge 40. In addition, second sloped panel 36 includes a first longitudinal edge 42 and a second longitudinal edge 44. As shown in FIGS. 1 and 3, first sloped panel 34 is pivotally connected at its first longitudinal edge 38 at or adjacent the first longitudinal edge 26 of the first side wall 14. Similarly, second sloped panel 32 is pivotally connected at its first longitudinal edge 42 at or adjacent the first longitudinal edge 30 of the second side wall 16. In this embodiment, first and second, sloped panels 34 and 36 are pivotally connected with multiple hinges 46. However, a continuous piano hinge or other pivotal connection device could be used to attach the first and second sloped panels 34 and 36 to the first and second side walls 14 and 16.

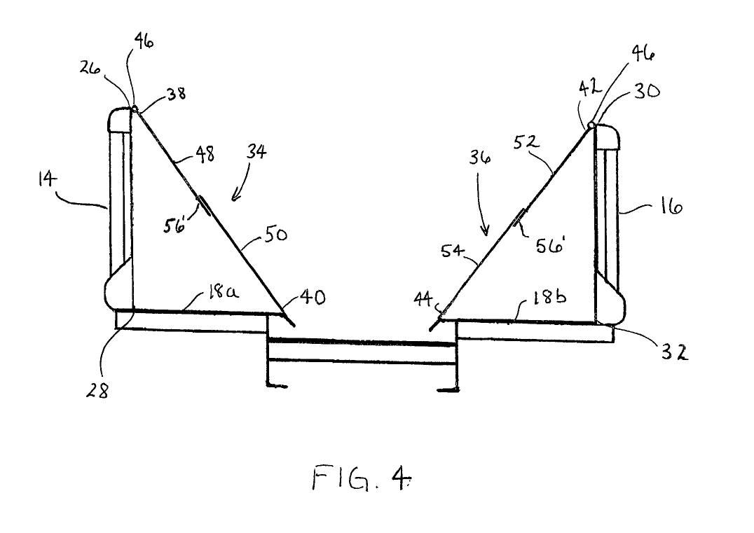

As shown in FIGS. 1-3, first sloped panel 34 includes a first longitudinal section 48 extending from the first longitudinal edge 38 of the first sloped panel 34 and a second longitudinal section 50 extending from the second longitudinal edge 40 of the first sloped panel 34, wherein the first longitudinal section 48 and the second longitudinal section 50 are pivotally attached to each other. Similarly, second sloped panel 36 includes a first longitudinal section 52 extending from the first longitudinal edge 42 of the second sloped panel 36 and a second longitudinal section 54 extending from the second longitudinal edge 44 of the second sloped panel 36, wherein the first longitudinal section 52 and the second longitudinal section 54 are pivotally attached to each other. In this particular embodiment, multiple hinges 56 are used to pivotally attach the first longitudinal sections 48, 52 to the second longitudinal sections 50, 54, however, a single piano hinge or other pivotal attachment device could be used. Alternatively, a sliding attachment 56′, where the first and second longitudinal sections are sliding sheets, one extending over the other, could be used, as shown in FIG. 4.

In FIG. 1, first and second sloped panels 34 and 36 are positioned in a lowered position such that first sloped panel 34 extends angularly between the first side wall 14 and the floor 18 and second sloped panel 36 extends angularly between the second side wall 16 and the floor 18.

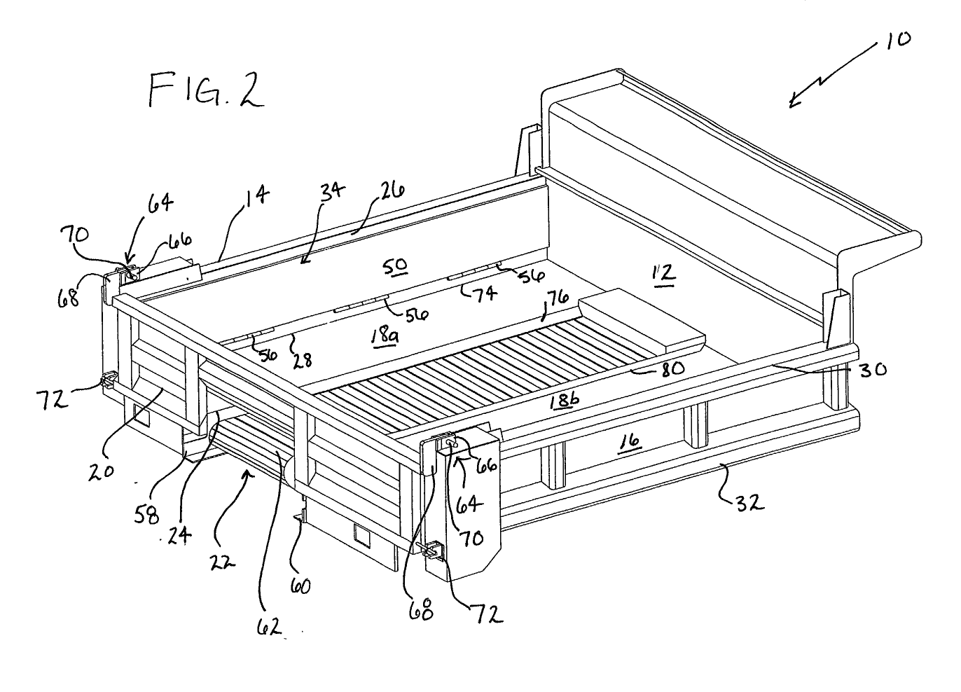

In FIG. 2, first and second sloped panels 34 and 36 are positioned in a substantially vertical raised position adjacent the first side wall 14 and second side wall 16, respectively. In this embodiment, first sloped panel 34 is positioned so that the first and second longitudinal sections 48 and 50, respectively, are adjacent each other and the substantially planar side wall 14 of the dump body 10 and second sloped panel 36 is positioned so that the first and second longitudinal sections 52 and 54, respectively, are adjacent each other and the substantially planar side wall 16 of the dump body 10. In an alternative embodiment, side walls 14 and 16 may include a recess for stowing first and second sloped panels 34 and 36, such that when first and second sloped panels 34 and 36 are in a substantially vertical raised position, a substantially planar inner surface is formed by the side walls 14 and 16 and the first and second sloped panels 34 and 36.

In the embodiment shown in FIGS. 1-3, single first and second sloped panels 34 and 36 extend from the front wall 12 to tailgate 20. However, in an alternative embodiment, a plurality of first and second sloped panels 34 and 36 may be attached longitudinally along side walls 14 and 16.

Referring to FIGS. 1 and 2, a conveyor system 22 is structurally integrated into the floor 18 substantially centrally between side walls 14 and 16. Suitable techniques for structurally integrating a conveyor system into a dump truck body floor are set forth, for example, in U.S. Pat. No. 4,886,214 to Musso, Jr. et al., U.S. Pat. No. 5,397,172 to Musso, Jr. et al., U.S. Pat. No. 5,400,974 to Musso, Jr. et al., and U.S. Pat. No. 5,927,617 to Musso, Jr. et al., which are hereby incorporated by reference in their entirety.

In this particular embodiment, the conveyor system 22 is an endless conveyor, with front and rear sprocket shafts which may be substantially identical, each having a pair of laterally spaced sprockets, a conveyor motor for driving the conveyor, a power supply, and a control panel. Each sprocket shaft is rotatably secured to support members 58 and 60 of the dump body 10. One sprocket shaft is positioned below the aperture 24. The sprocket shafts rotate about an axis which is substantially parallel with front wall 12 and tailgate 20. Each end of each sprocket shaft has a set of radially extending teeth located around its circumference.

The conveyor system 22 includes a pair of chains (not shown) which are secured together by bars 62 which extend in a substantially perpendicular direction between the chains and are spaced at substantially equal distances apart. The chains are wrapped around and extend between opposing shafts, with the teeth on one side of the sprocket shafts engaged to mesh with one chain, i.e. seated in openings in the chain, and the teeth on the opposing side of the sprocket shafts engaged to mesh with the other chain. In the embodiment shown in FIGS. 1 and 2, conveyor system 22 is integrated in or seated within a recess in floor 18, e.g., in this particular embodiment the recess is about one to two inches below the plane of floor 18, extends between front wall 12 and tailgate 20, and is centrally located between side walls 14 and 16.

A conveyor motor (not shown) is secured to dump body 10 and is coupled to one of the sprocket shafts by a driving shaft. The motor is also coupled to a power supply (not shown) and also to a control panel (not shown) which may be located in the cab of the truck including the dump truck body 10. When the motor is engaged, the motor rotates the drive shaft and sprocket shafts driving conveyor system 22. With the control panel, operations such as when the conveyor system 22 is engaged, the direction in which conveyor system 22 runs, and the rate at which conveyor system 22 runs can be controlled in a manner well known to those skilled in the art. In this particular embodiment, an electric motor is used as the drive mechanism, although other systems for driving conveyor system 22 could be used, such as a hydraulic system. By changing the direction of rotation of the driving shaft and thus of the sprocket shafts, conveyor system 22 can be operated to run in either direction, i.e. either towards the front wall 12 or towards the tailgate 20. As a result, the dump truck body 10 can be operated to convey materials to either the front or the back of the dump truck body 10.

Although one type of conveyor system 22 is described, any type of conveyor, such as the conveyors shown in U.S. Pat. No. 4,886,214 to Musso, Jr. et al., U.S. Pat. No. 5,310,119 to Musso, Jr. et al., and U.S. Pat. No. 5,397,172 to Musso, Jr. et al. which are hereby incorporated by reference in their entirety, could be used. Additionally, any type of conveyor or moving system, such as an auger system disclosed in U.S. Pat. No. 2,879,910 to Johnson and U.S. Pat. No. 5,927,617 to Musso, Jr. et al., which are hereby incorporated by reference in their entirety, could also be used. In an alternative embodiment, the dump truck body 10 may be provided without a conveyor system 22.

As shown in FIGS. 1 and 3, in this particular embodiment, the second longitudinal edge 40, 44 of the first and second sloped panels 34 and 36 is adjacent and in contact with the floor adjacent the conveyor system 22, when the first and second sloped panels are in the lowered position. In addition, in this particular embodiment, the conveyor system 22 is centrally located. However, the conveyor system 22 could be located at any position between side walls 14 and 16 and more than one conveyor system 22 could be used.

Referring to FIGS. 1 and 2, tailgate 20 includes aperture 24. Aperture 24 extends through tailgate 20 to the interior of dump body 10. In this particular embodiment, one aperture 24 is present, although dump body 10 could be manufactured to have additional apertures 24, as needed or desired. The aperture 24 is in alignment with the end of conveyor system 22 for dispensing of material within the dump truck body. In an alternative embodiment, aperture 24 could be located in the floor, for example, when conveying material to the front of the truck body 10.

As shown in FIGS. 1 and 2, tailgate 20 is pivotally mounted at pivot points or connections 64 to side walls 14 and 16. In this particular embodiment, each pivot point 64 includes a flange 66 with an opening (not shown), an L-shaped bracket 68, with an opening (not shown), and a pivot pin 70 extending through the openings in the flange and L-shaped bracket. Each flange 66 extends upwardly from the top of each side wall 14 and 16 adjacent tailgate 20. Each flange 66 has an opening designed to receive a pivot pin 70. The openings in flanges 66 are located along the same transverse axis. A bracket 68, which in this particular embodiment has an L-shape, is secured at one end to each side of the top of the tailgate 20. The other end of each bracket 68 also has an opening designed to receive a pivot pin 70. The opening in each bracket 68 is aligned with the opening in one of the flanges 66 and a pivot pin 70 extends through the openings to create the pivotal point or connection 64. Pivot pins are held in place by a nut, cotter pin, or other securing device. Although one type of pivot connection or point 64 is disclosed, other types of pivotal connections or points could be used, such as that disclosed in U.S. Pat. No. 5,397,172 to Musso, Jr., et al., which is hereby incorporated by reference in its entirety. Although not shown, pivot points may also be provided at the bottom of the tailgate 20, if needed or desired.

The lower end of tailgate 20 is secured by a latching system 72. Suitable latching systems are described, for example, in U.S. Pat. No. 5,397,172 to Musso Jr., et al. and U.S. Pat. No. 5,927,617 to Musso Jr., et al., which are hereby incorporated by reference in their entirety.

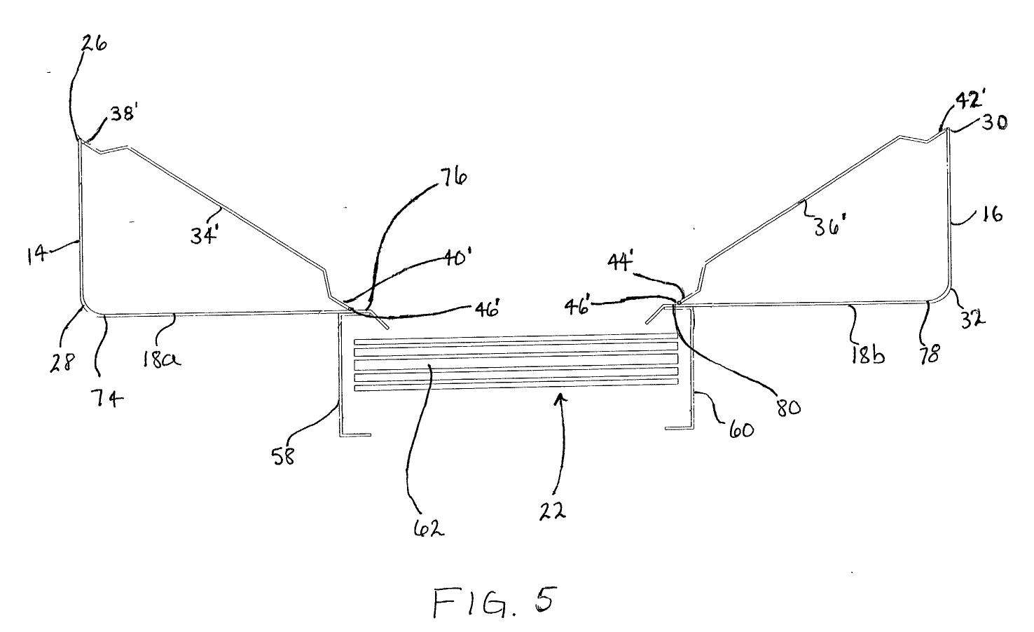

A dump truck body 10 in accordance with a second embodiment of the present invention is shown in FIGS. 5-7. In this embodiment, the dump truck body 10 is identical to the above-described dump truck body, except as described below.

Referring to FIGS. 5-7, in this particular example, the dump truck body 10 includes first and second sloped panels 34′ and 36′ which are pivotally connected at their second longitudinal edges 40′, 44′ to the floor 18 adjacent the longitudinally extending conveyor system. In this embodiment, first and second, sloped panels 34′ and 36′ are pivotally connected with multiple hinges 46′. However, a continuous piano hinge or other pivotal attachment device could be used to attach the first and second sloped panels 34′ and 36′ to the floor 18 adjacent the conveyor system 22.

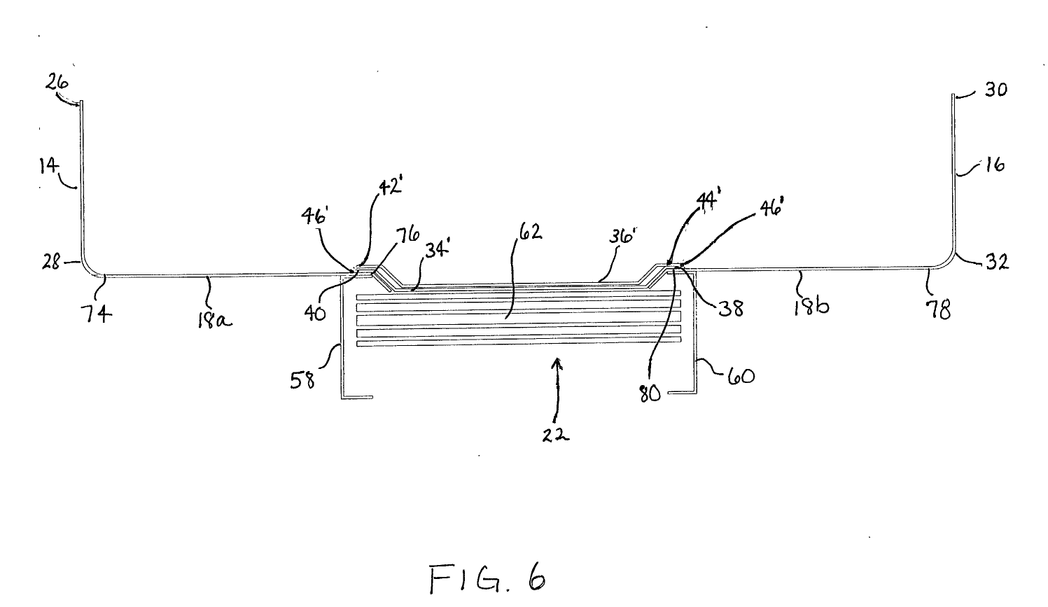

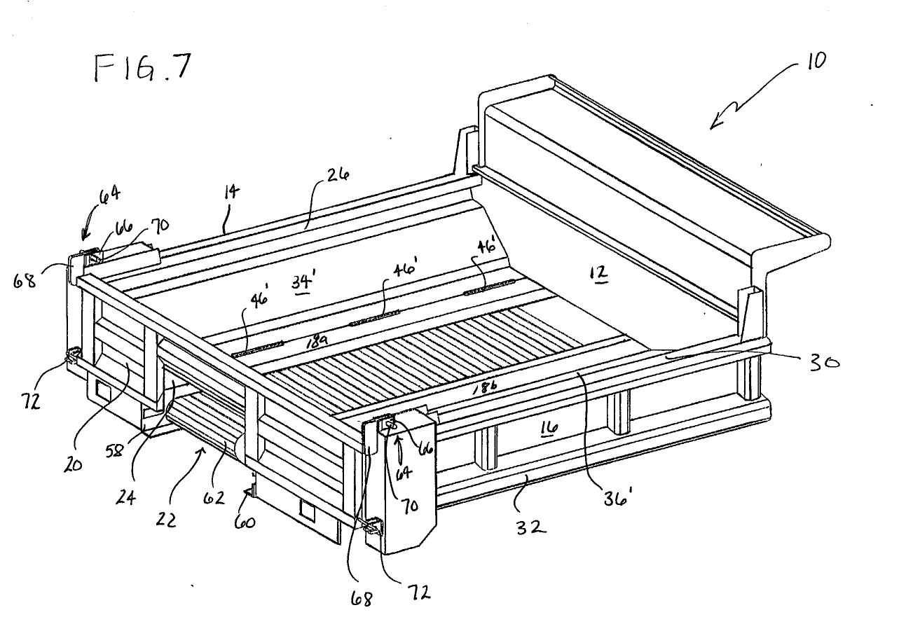

In FIGS. 5 and 7, first and second sloped panels 34′ and 36′ are positioned in a raised position such that first and second sloped panels 34′ and 36′ extend angularly between the first and second side walls 14 and 16 and the floor 18. In FIG. 6, first and second sloped panels 34′ and 36′ are positioned in a substantially horizontal lowered position covering the conveyor system 22. In this position, first and second sloped panels 34′ and 36′ protect the conveyor system 22 when not in use.

In the embodiment shown in FIGS. 5-7, single first and second sloped panels 34′ and 36′ extend from the front wall 12 to tailgate 20. However, in an alternative embodiment, a plurality of first and second sloped panels 34′ and 36′ may be attached longitudinally along floor 18 on either side of the conveyor system 22.

The sloped panels 34′ and 36′ direct the material contained within the dump body towards the centrally located conveyor system 22 when positioned in the raised operative position shown in FIGS. 5 and 7. In the embodiment shown in FIGS. 5 and 7, the sloped panels slope downwardly and inwardly toward the conveyor system 22 and are attached to the floor 18 on either side of the conveyor system. In particular, in this embodiment, first sloped panel 34′ extends from the first longitudinal edge 26 of side wall 14 to the floor adjacent and on one side of conveyor system 22 and second sloped panel 36′ extends from the first longitudinal edge 30 of side wall 16 to the floor adjacent and on the other side of conveyor system 22. However, the position at which the first and second sloped panels 34′ and 36′ contact the side walls 14 and 16 can be varied as desired. The use of first and second sloped panels 34′ and 36′ which extend substantially from first longitudinal edges 26, 30 of side walls 14 and 16 to the conveyor system 22 produces a double side wall and floor design, which provides additional strength for holding materials within the dump truck body 10. When positioned in the lowered, inoperative position, the first and second sloped panels 34′ and 36′ cover and protect the conveyor system 22.

In this particular embodiment, side walls 14 and 16 are approximately seventeen inches, floor 18 is approximately eighty-four inches between side walls 14 and 16, and first and second sloped panels 34′ and 36′ are approximately thirty-two and a half inches, hinged at approximately twenty-five and a half inches from side walls 14 and 16, so that first sloped panel 34′ extends from the first longitudinal edge 26 of side wall 14 to the floor adjacent and on one side of conveyor system 22 and second sloped panel 36′ extends from the first longitudinal edge 30 of side wall 16 to the floor adjacent and on the other side of conveyor system 22.

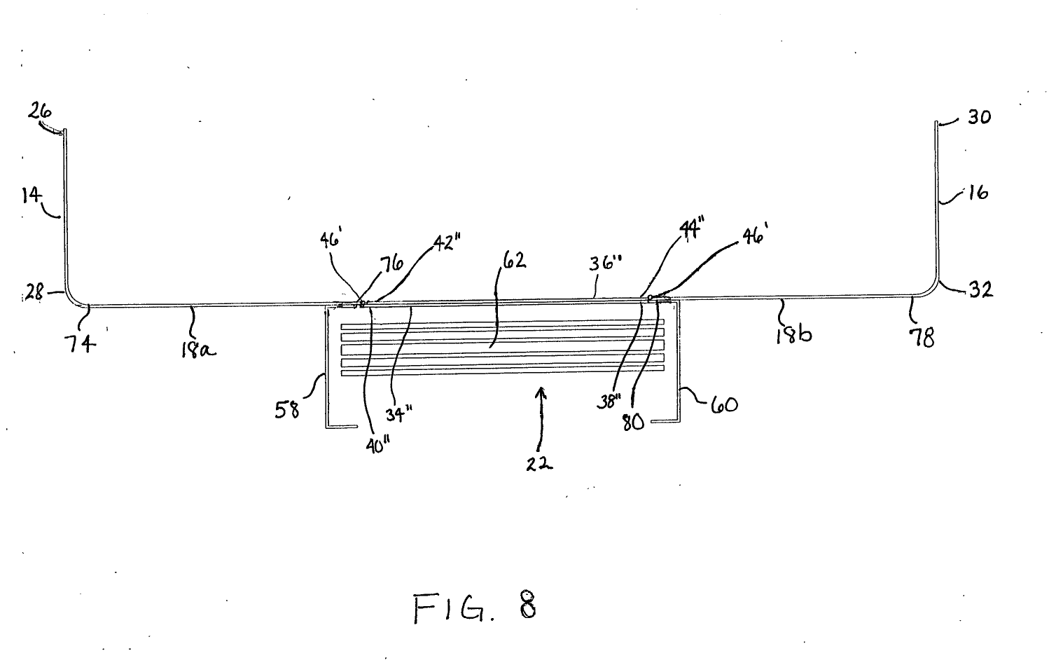

In addition, in this particular embodiment, first and second sloped panels 34′ and 36′ are non-planar and produce a recess in floor 18 over conveyor system 22, as shown in FIG. 6. However, first and second sloped panels may be substantially planar (34″ and 36″) with first longitudinal edges 38″, 42″ and second longitudinal edges 40″, 44″, as shown in FIG. 8. Substantially planar first and second sloped panels 34″ and 36″ may be positioned to produce a substantially planar bottom to the dump truck body 10 which includes floor 18a, 18b and planar first and second sloped panels 34″ and 36″ in substantially horizontal, lowered positions.

Referring to FIGS. 1-8, the floor 18 comprises a longitudinally extending opening in alignment with the conveyor system 22. In particular, the floor 18 comprises first and second substantially planar sections 18a and 18b. The first substantially planar section 18a has a first end 74 adjacent and in contact with the first side wall 14 and a second end 76 adjacent the conveyor system 22. The second substantially planar section 18b has a first end 78 adjacent and in contact with the second side wall 16 and a second end 80 adjacent the conveyor system 22. The first and second substantially planar sections 18a, 18b define an opening extending therebetween. The opening is positioned over the conveyor system 22 and allows material within the dump truck body 10 to contact the conveyor system 22 for dispensing out of the dump truck body 10. Although this embodiment of the invention includes a single longitudinally extending opening, multiple openings could be used. Alternatively, the opening(s) may not extend the entire length of the floor 18 of the dump body 10.

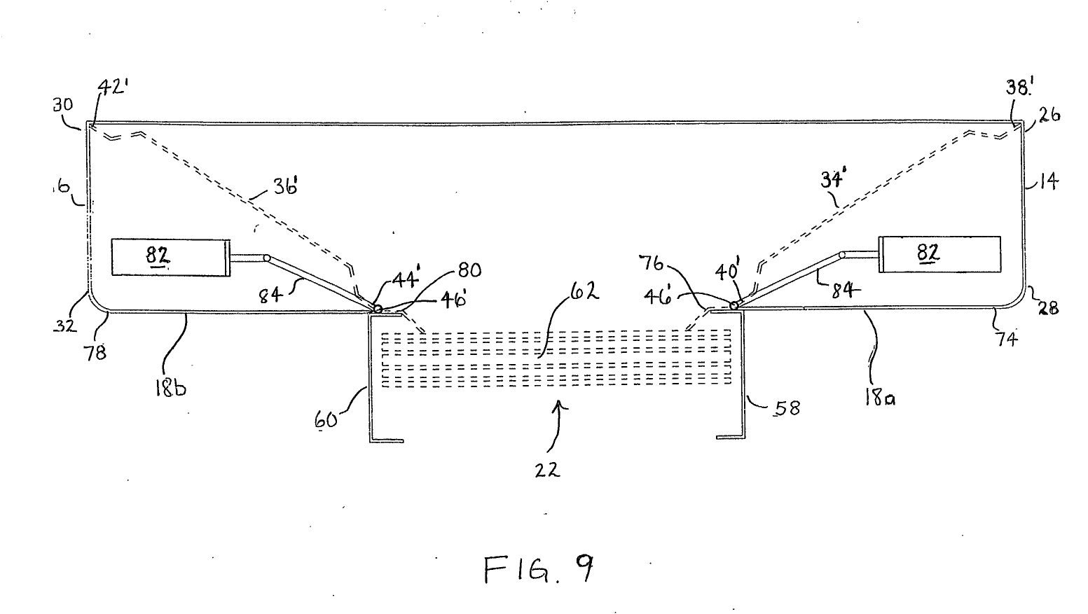

A dump truck body 10 in accordance with a third embodiment of the present invention is shown in FIG. 9. In this embodiment, the dump truck body 10 is identical to the above-described dump truck body in accordance with the second embodiment of the present invention, except as described below.

In the embodiment shown in FIG. 9, the dump truck body 10 includes hydraulic cylinders 82 functionally connected to the first and second sloped panels 34′ and 36′. In particular, hydraulic cylinders 82 are attached to the outside of front wall 12. The hinge rod for hinges 46 extends through front wall 12 and is connected to the hydraulic cylinders through a cylinder attachment bar 84. Upon actuation of the hydraulic cylinders 82, the hinge rod of hinges 46 is rotated, thereby rotating first and second sloped panels 34′ and 36′ between the raised, operative position shown in FIG. 5 and the lowered, inoperative position shown in FIG. 6. Although hydraulic cylinders 82 are used in this embodiment, other automatic devices for rotating first and second sloped panels 34′ and 36′ may be used.

In another alternative embodiment of the present invention, an auger system may be positioned in floor 18 of dump body 10 where the conveyor system 22 is now shown. Suitable auger systems are known in the art and are described, for example, in U.S. Pat. No. 5,927,617 to Musso, Jr. et al., which is hereby incorporated by reference in its entirety.

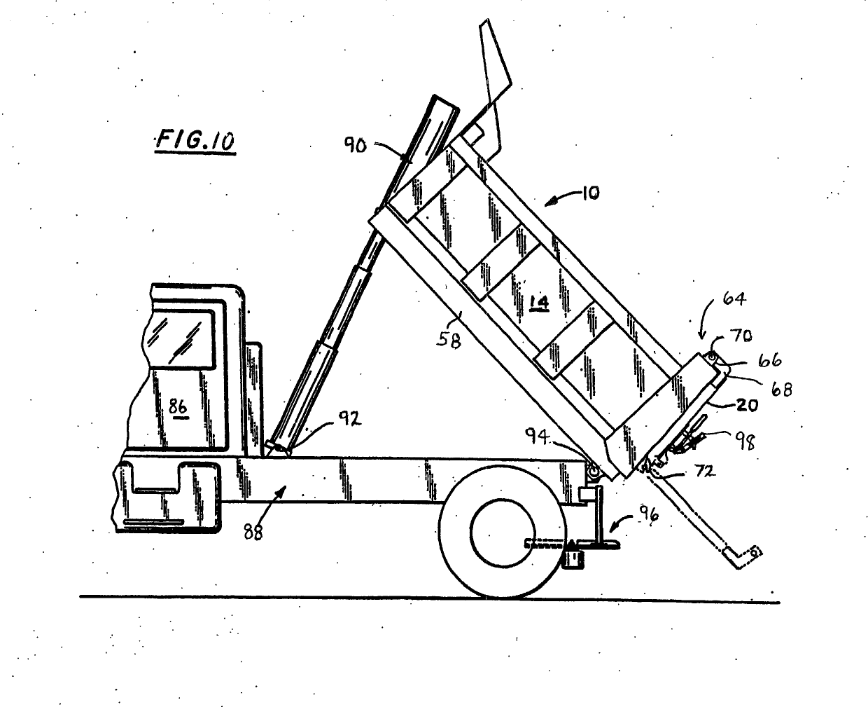

Referring to FIG. 10, a truck 86 including a dump truck body 10 in accordance with the present invention is shown. The truck 86 includes a truck frame 88, a lift cylinder 90, and dump body 10.

Referring to FIG. 10, lift cylinder 88 is a telescoping lift cylinder which includes first, second, and third telescoping tubular sections. Second tubular section is seated within first tubular section and third tubular section is seated within the second tubular section, and the lift cylinder can extend in and out in a manner well known to those skilled in the art. One end of first tubular section is pivotally mounted at a pivot point 92 to truck frame 88 and one end of the third tubular section is pivotally mounted at a pivot point (not shown) to the outer surface of front wall 12. In this particular embodiment, lift cylinder 90 is mounted to truck frame 88 and along the outside of front wall 12, although lift cylinder 90 could be mounted in other locations, such as beneath dump body 10. A lift cylinder system, such as those shown in U.S. Pat. No. 4,886,214 to Musso, Jr. et al., U.S. Pat. No. 5,310,119 to Musso, Jr. et al., U.S. Pat. No. 5,397,172 to Musso, Jr. et al., and U.S. Pat. No. 5,927,617 to Musso, Jr. et al., which are hereby incorporated by reference in their entirety, could be used. When lift cylinder 90 is raised, extending the second tubular section from the first tubular section and extending the third tubular section from the second tubular section, dump body 10 is raised to pivot up and around pivot points or connections 94. Support members 58 and 60 proximate to tailgate 20 are pivotally connected at pivot points or connections 94 to truck frame 88.

As shown in FIG. 10, a dispensing system 96 may be secured to the dump body 10 to provide a multiple purpose truck, which may be used in both a dump mode and a conveyor dispensing mode. Suitable dispensing systems include, but are not limited to, front and rear, rotary spreaders, such as those described in U.S. Pat. Nos. 4,886,214, 5,310,119, and 5,397,172, each to Musso Jr., et al., which are hereby incorporated by reference in their entirety.

Referring to FIG. 10, a door 98 may be adjustably secured to tailgate 20 of dump body 10 between positions covering and exposing aperture 24. In particular, door 98 is moveable between a first raised position exposing aperture 24 and resting above conveyor system 22 and a second lowered position covering the aperture 24 and resting on conveyor system 22 by sliding door 98 down and towards conveyor system 22. Door 98 may also be moved to intermediate positions between the first raised position and the second lowered position. The door 98 is used to control the size of aperture 24 which helps control the rate at which material in dump body 10 is dispensed.

Any type of door operating mechanism which can move the door between the first and second positions, to intermediate positions between the first and second positions, and any kind of door locking mechanism can be used, such as in U.S. Pat. No. 5,397,172 to Musso Jr. et. al and U.S. Pat. No. 5,927,617 to Musso Jr. et al., which are hereby incorporated by reference in their entirety.

The operation of truck 86 with dump body 10 in accordance with the present invention will be discussed with reference to FIGS. 1-10. To produce a hopper-type dump body, the operator manually or automatically moves first and second sloped panels 34 and 36 (or 34′ and 36′ or 34″ and 36″) into an operative position, such that the panels 34 and 36 (or 34′ and 36′ or 34″ and 36″) extend angularly between the side walls 14, 16 and the floor 18. Dump body 10 is then filled with material, such as road salt, gravel, or soil. Truck 86 is driven to the location where the material needs to be dispensed. Depending upon the particular application, the operator opens the door 98 in tailgate 20 (or opens the door in floor 18, when present). The amount the operator opens the door 98 will impact the rate at which material is dispensed from dump body 10. The operator will then fasten or lock the door 98 in place.

The operator will then engage the conveyor system 22 (or auger) to begin conveying in the direction of the open door 98. The material in the dump body 10 is conveyed through the aperture 24 in the tailgate 20 (or in floor 18) with the open door 98. If truck 86 has a spreader system 96, the operator will also engage the spreader system 96. If present, the spreader 96 is disposed beneath aperture 24 and material from aperture 24 falls onto the spreader 96 and is dispersed.

When the contents in dump body 10 adjacent tailgate 20 are dispersed or nearly dispersed, the operator will stop the truck 86, disengage conveyor system 22 (or the auger) and spreader system 96, and raise lift cylinder 90 to raise dump body 10 around pivot points 94, as shown in FIG. 10. Raising dump body 10 redistributes the material in dump body 10 to the rear of truck 86 and adjacent tailgate 20. Once the material is redistributed, dump body 10 is lowered and the operator can resume the operations discussed above.

To produce a square-cornered dump body, the operator manually or automatically moves first and second sloped panels 34 and 36 (or 34′ and 36′ or 34″ and 36″) into an inoperative position, such that the panels 34 and 36 (or 34′ and 36′ or 34″ and 36″) extend in a substantially vertical raised position adjacent the side walls 14, 16 or in a substantially horizontal lowered position covering the conveyor system 22. Dump body 10 is then filled with material which is subsequently dispersed, as described above.

Although the invention has been described in detail for the purpose of illustration, it is understood that such detail is solely for that purpose, and variations can be made therein by those skilled in the art without departing from the spirit and scope of the invention which is defined by the following claims.

What is claimed is:

1. A dump truck body comprising:
a receptacle defined by a floor and, extending from the floor, first and second side walls on opposite sides of the floor, and a front wall extending between the side walls, wherein the first and second side walls have a first longitudinal edge distal from the floor and a second longitudinal edge proximal to the floor; and
at least one first sloped panel having a first longitudinal edge and a second longitudinal edge, wherein the first longitudinal edge of the at least one first sloped panel is pivotally connected at or adjacent the first longitudinal edge of the first side wall for pivotal movement between a raised position adjacent the first side wall and a lowered position extending angularly between the first side wall and the floor.

2. The dump truck body according to claim 1 further comprising at least one second sloped panel having a first longitudinal edge and a second longitudinal edge, wherein the first longitudinal edge of the at least one second sloped panel is pivotally connected at or adjacent the first longitudinal edge of the second side wall for pivotal movement between a raised position adjacent the second side wall and a lowered position extending angularly between the second side wall and the floor.

3. The dump truck body according to claim 2 wherein the at least one first sloped panel further comprises:
a first longitudinal section extending from the first longitudinal edge of the at least one first sloped panel; and
a second longitudinal section extending from the second longitudinal edge of the at least one first sloped panel, wherein the first longitudinal section and the second longitudinal section are attached to each other with a repositioning connector.

4. The dump truck body according to claim 3 wherein the at least one second sloped panel further comprises:
a first longitudinal section extending from the first longitudinal edge of the at least one second sloped panel; and
a second longitudinal section extending from the second longitudinal edge of the at least one second sloped panel, wherein the first longitudinal section and the second longitudinal section are attached to each other with a repositioning connector.

5. The dump truck body according to claim 4 wherein the repositioning connector is a hinge.

6. The dump truck body according to claim 4 wherein the repositioning connector is a sliding attachment.

7. The dump truck body according to claim 1 further comprising a longitudinally extending conveyor system structurally integrated into the floor between the first and second side walls, wherein the floor has at least one opening in alignment with the conveyor system.

8. The dump truck body according to claim 7 wherein the second longitudinal edge of the at least one first sloped panel is adjacent and in contact with the floor adjacent the longitudinally extending conveyor system when in the lowered position.

9. The dump truck body according to claim 1 further comprising a tailgate located on an opposite side of the floor from the front wall and extending between the first and second side walls.

10. A dump truck comprising:
a longitudinally extending truck frame;
a dump truck body pivotally mounted at a rear end thereof on the truck frame, wherein the dump truck body comprises:
a receptacle defined by a floor and, extending from the floor, first and second side walls on opposite sides of the floor, and a front wall extending between the side walls, wherein the first and second side walls have a first longitudinal edge distal from the floor and a second longitudinal edge proximal to the floor; and
at least one first sloped panel having a first longitudinal edge and a second longitudinal edge, wherein the first longitudinal edge of the at least one first sloped panel is pivotally connected at or adjacent the first longitudinal edge of the first side wall for pivotal movement between a raised position adjacent the first side wall and a lowered position extending angularly between the first side wall and the floor; and
a lift system connected between the truck frame and a forward end of the dump body.

11. The dump truck according to claim 10 wherein the dump truck body further comprises at least one second sloped panel having a first longitudinal edge and a second longitudinal edge, wherein the first longitudinal edge of the at least one second sloped panel is pivotally connected at or adjacent the first longitudinal edge of the second side wall for pivotal movement between a raised position adjacent the second side wall and a lowered position extending angularly between the second side wall and the floor.

12. The dump truck according to claim 11 wherein the at least one first sloped panel further comprises:
a first longitudinal section extending from the first longitudinal edge of the at least one first sloped panel; and
a second longitudinal section extending from the second longitudinal edge of the at least one first sloped panel, wherein the first longitudinal section and the second longitudinal section are attached to each other with a repositioning connector.

13. The dump truck according to claim 12 wherein the at least one second sloped panel further comprises:
a first longitudinal section extending from the first longitudinal edge of the at least one second sloped panel; and
a second longitudinal section extending from the second longitudinal edge of the at least one second sloped panel, wherein the first longitudinal section and the second longitudinal section are attached to each other with a repositioning connector.

14. The dump truck according to claim 13 wherein the repositioning connector is a hinge.

15. The dump truck according to claim 13 wherein the repositioning connector is a sliding attachment.

16. The dump truck according to claim 10 further comprising a longitudinally extending conveyor system structurally integrated into the floor between the first and second side walls, wherein the floor has at least one opening in alignment with the conveyor system.

17. The dump truck according to claim 16 wherein the second longitudinal edge of the at least one first sloped panel is adjacent and in contact with the floor adjacent the longitudinally extending conveyor system when in the lowered position.

18. The dump truck according to claim 10 wherein the dump truck body further comprises a tailgate located on an opposite side of the floor from the front wall and extending between the first and second side walls.

19. A dump truck body comprising:
a receptacle defined by a floor and, extending from the floor, first and second side walls on opposite sides of the floor, and a front wall extending between the side walls, wherein the first and second side walls have a first longitudinal edge distal from the floor and a second longitudinal edge proximal to the floor;
a longitudinally extending conveyor system structurally integrated into the floor between the first and second side walls, wherein the floor has at least one opening in alignment with the conveyor system; and
at least one first sloped panel having a first longitudinal edge and a second longitudinal edge, wherein the second longitudinal edge of the at least one first sloped panel is pivotally connected to the floor adjacent the longitudinally extending conveyor system for pivotal movement between a lowered position covering the conveyor system and a raised position extending angularly between the first side wall and the floor.

20. The dump truck body according to claim 19 further comprising at least one second sloped panel having a first longitudinal edge and a second longitudinal edge, wherein the second longitudinal edge of the at least one second sloped panel is pivotally connected to the floor adjacent the longitudinally extending conveyor system for pivotal movement between a lowered position covering the conveyor system and a raised position extending angularly between the second side wall and the floor.

21. The dump truck body according to claim 20 wherein the first longitudinal edge of the at least one first sloped panel is adjacent and in contact with the first longitudinal edge of the first side wall when in the raised position and wherein the first longitudinal edge of the at least one second sloped panel is adjacent and in contact with the first longitudinal edge of the second side wall when in the raised position.

22. The dump truck body according to claim 20 wherein the at least one first and second sloped panels are non-planar and have a recessed section over the conveyor system when in the lowered position.

23. The dump truck body according to claim 20 wherein the at least one first and second sloped panels are substantially planar with the floor when in the lowered position.

24. The dump truck body according to claim 19 further comprising a tailgate located on an opposite side of the floor from the front wall and extending between the first and second side walls.

25. A dump truck comprising:
a longitudinally extending truck frame;
a dump truck body pivotally mounted at a rear end thereof on the truck frame, wherein the dump truck body comprises:
a receptacle defined by a floor and, extending from the floor, first and second side walls on opposite sides of the floor, and a front wall extending between the side walls, wherein the first and second side walls have a first longitudinal edge distal from the floor and a second longitudinal edge proximal to the floor;
a longitudinally extending conveyor system structurally integrated into the floor between the first and second side walls, wherein the floor has at least one opening in alignment with the conveyor system; and
at least one first sloped panel having a first longitudinal edge and a second longitudinal edge, wherein the second longitudinal edge of the at least one first sloped panel is pivotally connected to the floor adjacent the longitudinally extending conveyor system for pivotal movement between a lowered position covering the conveyor system and a raised position extending angularly between the first side wall and the floor; and
a lift system connected between the truck frame and a forward end of the dump body.

26. The dump truck according to claim 25 wherein the dump truck body further comprises at least one second sloped panel having a first longitudinal edge and a second longitudinal edge, wherein the second longitudinal edge of the at least one second sloped panel is pivotally connected to the floor adjacent the longitudinally extending conveyor system for pivotal movement between a lowered position covering the conveyor system and a raised position extending angularly between the second side wall and the floor.

27. The dump truck according to claim 26 wherein the first longitudinal edge of the at least one first sloped panel is adjacent and in contact with the first longitudinal edge of the first side wall when in the raised position and wherein the first longitudinal edge of the at least one second sloped panel is adjacent and in contact with the first longitudinal edge of the second side wall when in the raised position.

28. The dump truck according to claim 26 wherein the at least one first and second sloped panels are non-planar and have a recessed section over the conveyor system when in the lowered position.

29. The dump truck according to claim 26 wherein the at least one first and second sloped panels are substantially planar with the floor when in the lowered position.

30. The dump truck according to claim 25 wherein the dump truck body further comprises a tailgate located on an opposite side of the floor from the front wall and extending between the first and second side walls.

31. A dump truck body comprising:
a receptacle defined by a floor and, extending from the floor, first and second side walls on opposite sides of the floor, and a front wall extending between the side walls, wherein the first and second side walls have a first longitudinal edge distal from the floor and a second longitudinal edge proximal to the floor;
a longitudinally extending conveyor system structurally integrated into the floor between the first and second side walls, wherein the floor has at least one opening in alignment with the conveyor system; and
at least one first sloped panel having a first longitudinal edge and a second longitudinal edge, wherein the first longitudinal edge of the at least one first sloped panel is pivotally connected at or adjacent the first longitudinal edge of the first side wall or to the floor adjacent the longitudinally extending conveyor system for pivotal movement between a sloped position extending angularly between the first side wall and the floor and a non-sloped position.

32. The dump truck body according to claim 31 further comprising at least one second sloped panel having a first longitudinal edge and a second longitudinal edge, wherein the first longitudinal edge of the at least one second sloped panel is pivotally connected at or adjacent the first longitudinal edge of the second side wall or to the floor adjacent the longitudinally extending conveyor system for pivotal movement between a sloped position extending angularly between the second side wall and the floor and a non-sloped position.

33. The dump truck body according to claim 32 wherein the at least one first sloped panel further comprises:
a first longitudinal section extending from the first longitudinal edge of the at least one first sloped panel; and
a second longitudinal section extending from the second longitudinal edge of the at least one first sloped panel, wherein the first longitudinal section and the second longitudinal section are attached to each other with a repositioning connector.

34. The dump truck body according to claim 33 wherein the at least one second sloped panel further comprises:
a first longitudinal section extending from the first longitudinal edge of the at least one second sloped panel; and
a second longitudinal section extending from the second longitudinal edge of the at least one second sloped panel, wherein the first longitudinal section and the second longitudinal section are attached to each other with a repositioning connector.

35. The dump truck body according to claim 34 wherein the repositioning connector is a hinge.

36. The dump truck body according to claim 34 wherein the repositioning connector is a sliding attachment.

37. The dump truck body according to claim 31 further comprising a tailgate located on an opposite side of the floor from the front wall and extending between the first and second side walls.

38. A dump truck comprising:
a longitudinally extending truck frame;
a dump truck body pivotally mounted at a rear end thereof on the truck frame, wherein the dump truck body comprises:
a receptacle defined by a floor and, extending from the floor, first and second side walls on opposite sides of the floor, and a front wall extending between the side walls, wherein the first and second side walls have a first longitudinal edge distal from the floor and a second longitudinal edge proximal to the floor;
a longitudinally extending conveyor system structurally integrated into the floor between the first and second side walls, wherein the floor has at least one opening in alignment with the conveyor system; and
at least one first sloped panel having a first longitudinal edge and a second longitudinal edge, wherein the first longitudinal edge of the at least one first sloped panel is pivotally connected at or adjacent the first longitudinal edge of the first side wall or to the floor adjacent the longitudinally extending conveyor system for pivotal movement between a sloped position extending angularly between the first side wall and the floor and a non-sloped position; and
a lift system connected between the truck frame and a forward end of the dump body.

39. The dump truck according to claim 38 wherein the dump truck body further comprises at least one second sloped panel having a first longitudinal edge and a second longitudinal edge, wherein the first longitudinal edge of the at least one second sloped panel is pivotally connected at or adjacent the first longitudinal edge of the second side wall or to the floor adjacent the longitudinally extending conveyor system for pivotal movement between a sloped position extending angularly between the second side wall and the floor and a non-sloped position.

40. The dump truck according to claim 39 wherein the at least one first sloped panel further comprises:
a first longitudinal section extending from the first longitudinal edge of the at least one first sloped panel; and
a second longitudinal section extending from the second longitudinal edge of the at least one first sloped panel, wherein the first longitudinal section and the second longitudinal section are attached to each other with a repositioning connector.

41. The dump truck according to claim 40 wherein the at least one second sloped panel further comprises:
a first longitudinal section extending from the first longitudinal edge of the at least one second sloped panel; and
a second longitudinal section extending from the second longitudinal edge of the at least one second sloped panel, wherein the first longitudinal section and the second longitudinal section are attached to each other with a repositioning connector.

42. The dump truck according to claim 41 wherein the repositioning connector is a hinge.

43. The dump truck according to claim 41 wherein the repositioning connector is a sliding attachment.

44. The dump truck according to claim 38 wherein the dump truck body further comprises a tailgate located on an opposite side of the floor from the front wall and extending between the first and second side walls.
